(19) United States
(12) Patent Application Publication
(10) Pub. No.: US 2003/0182344 A1
(43) Pub. Date: Sep. 25, 2003

(54) Integrated multiplier circuit with interchanged interconnections

(76) Inventor: Tsutomu Shimotoyodome, Tokyo (JP)

Correspondence Address: RABIN & CHAMPAGNE, PC, 1101 14TH STREET, NW, SUITE 500, WASHINGTON, DC, 20005, US

(21) Appl. No.: 10/354,125

(22) Filed: Jan. 30, 2003

(30) Foreign Application Priority Data
Mar. 22, 2002 (JP) 2002-080001

(51) Int. Cl. G06F 7/52

(52) U.S. Cl. 708/630

(57) ABSTRACT

An integrated multiplier circuit includes an array of one-bit adders, organized into a plurality of stages with a plurality of bit positions in each stage. Each one-bit adder has a carry input terminal and a pair of addend input terminals, and receives a carry signal and two addend signals. The carry signal is normally generated in the preceding bit position in the preceding stage of the array, and is received at the carry input terminal, but if the carry signal arrives with less delay than one of the two addend input signals, it is input at the corresponding addend input terminal, and the more delayed addend input signal is input at the carry input terminal. This input arrangement reduces the total time needed to complete a multiplication operation.

### BACKGROUND OF THE INVENTION

1. Field of the Invention

The present invention relates to a high-speed multiplier circuit in which a plurality of one-bit adders are connected in an array and operate simultaneously so that addition is performed in different bit positions in a temporally overlapping manner. More particularly, the invention relates to a method of increasing the multiplication speed by changing the interconnections of the one-bit adders.

2. Description of the Related Art

It is known that multiplication can be performed by logic circuits: for example, by a multiplier circuit comprising a single adder, a plurality of registers (for storing the multiplicand, the multiplier, the product, etc.), and a control circuit for shifting bit positions. It is also known that when the multiplier circuit is implemented in an integrated circuit, the multiplication operation can be carried out at a higher speed by using an array of one-bit adders that perform addition in different bit positions in a temporally overlapping manner. In this type of multiplier, each adder in the array receives a pair of addends (conventionally denoted x and y) and a carry input signal (c-in), and generates a sum signal (s) and a carry output signal (c-out)

In general, in any circuit that performs an arithmetic or logic operation, the operation is accompanied by a certain temporal delay. This is also true of an adder. In a multiplier circuit comprising an array of adders, the delays generated by the individual adders add up so that the completion of the multiplication is delayed by an even greater amount.

The delays add up because even if the adders perform multiplication in a temporally overlapping manner, when an operation (addition) is performed in an upper bit position or a later stage of the array, it is necessary to wait for a carry signal from the preceding bit position or a sum signal from the preceding stage of the array, or in many cases for both of these signals. In a multiplier circuit comprising an array of one-bit adders, each additional adder entails an additional wait, so the total delay increases toward higher bit positions, and toward later stages in the array. The speed of an integrated multiplier circuit is therefore normally determined by the delay of the adder in the highest bit position in the last stage of the array.

The one-bit adders in the array can be interconnected in various ways. FIG. 6 shows the structure of a conventional multiplier circuit with an array of the carry save type.

The multiplier (a) is a five-bit binary number comprising bits a0, a1, a2, a3, a4, of which a0 is the least significant bit (LSB). The multiplicand (b) is another five-bit binary number comprising bits b0, b1, b2, b3, b4, of which b0 is the LSB. The product (z) is a ten-bit binary number comprising bits z0 (the LSB), z1, z2, z3, z4, z5, z6, z7, z8, z9.

The multiplier circuit in FIG. 6 has five stages with four adders each. The five stages correspond to bits b1-b4, with one additional final stage. The twenty adders are denoted F(i), where i is a positive integer. Adder F(i) receives addend bits x(i) and y(i) and a carry signal c(i)-in as inputs, and generates a sum bit s(i) and a carry signal c(i)-out as outputs. The first adder F(1), for example, has the following inputs:

x(1)=a(1)*b(0)

y(1)=a(0)*b(1)

c(1)=0

For brevity, F(i), x(i), y(i), s(i), and c(i)-in are denoted Fi, xi, yi, si, and ci in FIG. 6. The notations with and without parentheses will be used interchangeably below.

Each one-bit adder F(i) has, for example, the structure shown in FIG. 7, comprising two logical exclusive-OR gates (EX-OR1, EX-OR2), two logical AND gates (AND1, AND2), and one logical OR gate (OR). The EX-OR1 logic gate receives addends x(i) and y(i), performs a logical exclusive OR operation, and supplies the result to the EX-OR2 and AND2 logic gates. The EX-OR2 logic gate receives the result output from EX-OR1 and the carry input signal c(i)-in, performs a logical exclusive OR operation, and outputs the sum s(i). The AND1 logic gate receives addends x(i) and y(i), performs a logical AND operation, and supplies the result to the OR logic gate. The AND2 logic gate receives the result output from the EX-OR1 logic gate and the carry input signal c(i)-in, performs a logical exclusive OR operation, and supplies the result to the OR logic gate. The OR logic gate receives the results output from the AND1 and AND2 logic gates, performs a logical OR operation, and outputs the result as the carry output signal c(i)-out.

In comparison with the AND1, AND2, and OR logic gates, the logical exclusive-OR gates EX-OR1 and EX-OR2 require a longer time to perform a logical operation on the input values and to output the result. The required time is referred to below as a delay. In the subsequent description, the delay of the AND1, AND2, and OR gates is assumed to be 1t while the delay of EX-OR1 and EX-OR2 is assumed to be 2t.

The path from x(i) to s(i) accordingly has a 4t delay. The path from y(i) to s(i) also has a 4t delay. The paths from c(i)-in to s(i), from x(i) to c(i)-out, from y(i) to c(i)-out, and from c(i)-in to c(i)-out have a 2t delay. The path with the longest delay in a circuit is referred to as the critical path.

Adder F1 in FIG. 6 outputs a sum s1 with a 4t delay (the critical-path delay within the adder), and outputs a carry signal c5 with a 2t delay. The carry output signal c5 becomes a carry input signal to adder F5. Adder F2 outputs a sum s2 with a 4t delay (the critical-path delay within the adder), and outputs a carry signal c6 with a 2t delay.

Adder F5 receives addends x5 and y5, of which x5 has a 4t input delay, and carry signal c5 with a 2t input delay, and outputs a sum s5 and a carry signal c9 with longer delays. The delay of s5 is the sum of the 4t input delay of addend x5 and the critical-path delay in the adder F5, or 8t in total. The delay of the carry output signal c9 is the sum of the 4t delay of the addend x5 and the delay of the carry signal in the adder F5, or 6t in total. In the subsequent description, the delay of a signal means the delay on the critical path for that signal, unless otherwise specified.

FIG. 8 lists the inputs and outputs of the adders in the multiplier circuit shown in FIG. 6. Because the adders in each stage generate additional delays, the final delay Z0 of the output of adder F20, which produces the most significant bit in the final stage, is 28t, as indicated in FIGS. 6 and 8. This 28t delay is the time that the multiplier circuit F(i) requires to complete the multiplication operation.

### SUMMARY OF THE INVENTION

An object of the present invention is to increase the speed of an integrated multiplier circuit.

The invented integrated multiplier circuit, like the conventional integrated multiplier circuit described above, comprises an array of one-bit adders, organized into a plurality of stages with a plurality of bit positions in each stage. Each one-bit adder has a carry input terminal and a pair of addend input terminals, and receives a carry input signal and two addend input signals.

In the second and subsequent stages of the array, the carry input signal is normally generated as a carry output signal in the preceding bit position in the preceding stage of the array. In at least one adder, however, this carry output signal is received with less delay than one of the addend input signals, and is interchanged with that addend input signal. That is, the carry output signal from the preceding bit position in the preceding stage is brought to an addend input terminal, and what would otherwise have been an addend input signal is brought to the carry input terminal.

Since the carry input to an adder is processed with less internal delay than the addend inputs, the invention reduces the maximum delay of the signals output from the adder. As a result, the multiplication operation is completed in less time than required by the conventional integrated multiplier circuit.

The invention also provides a method of interconnecting the one-bit adders in an integrated multiplier circuit of the above general type, in which each adder has three input terminals, one of the three inputs is processed with less internal delay than the other two inputs, and each interconnection is from an adder in one stage to an adder in either a later stage or a higher bit position in the same stage. The adders are considered one by one, preceding from the first stage to the last stage of the array and from the lowest bit position to the highest bit position in each stage. The delays of the three signals received by the adder under consideration are compared, and if one of the three signals is received with a greater delay than the other two signals, it is connected to the input terminal having the least internal processing delay. Then the delays of the signals output from the adder under consideration are calculated.

### BRIEF DESCRIPTION OF THE DRAWINGS

In the attached drawings:

FIG. 1 is a truth table describing the operation of adder circuits used in the present invention;

FIG. 2 is a block diagram of a multiplier circuit comprising an array of one-bit adders, illustrating a first embodiment of the invention;

FIG. 3 lists the inputs and outputs of the adders in the multiplier circuit shown in FIG. 2;

FIG. 4 is a block diagram of a multiplier circuit comprising an array of one-bit adders, illustrating a second embodiment of the invention;

FIG. 5 lists the inputs and outputs of the adders in the multiplier circuit shown in FIG. 4;

FIG. 6 is a block diagram of a conventional multiplier circuit comprising an array of one-bit adders;

FIG. 7 shows the internal logic structure of a one-bit adder; and

FIG. 8 lists the inputs and outputs of the adders in the multiplier circuit shown in FIG. 6.

### DETAILED DESCRIPTION OF THE INVENTION

Embodiments of the invention will now be described with reference to the attached drawings, in which like elements are indicated by like reference characters.

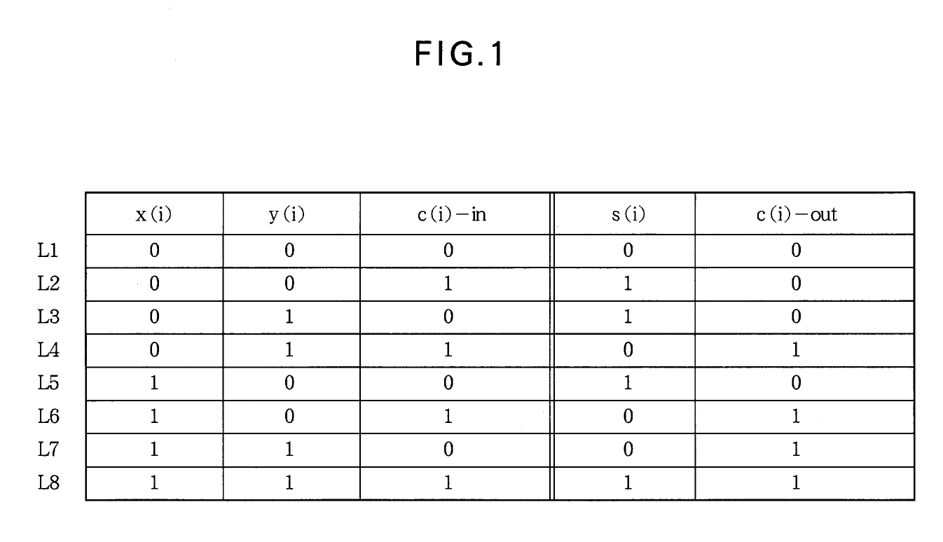

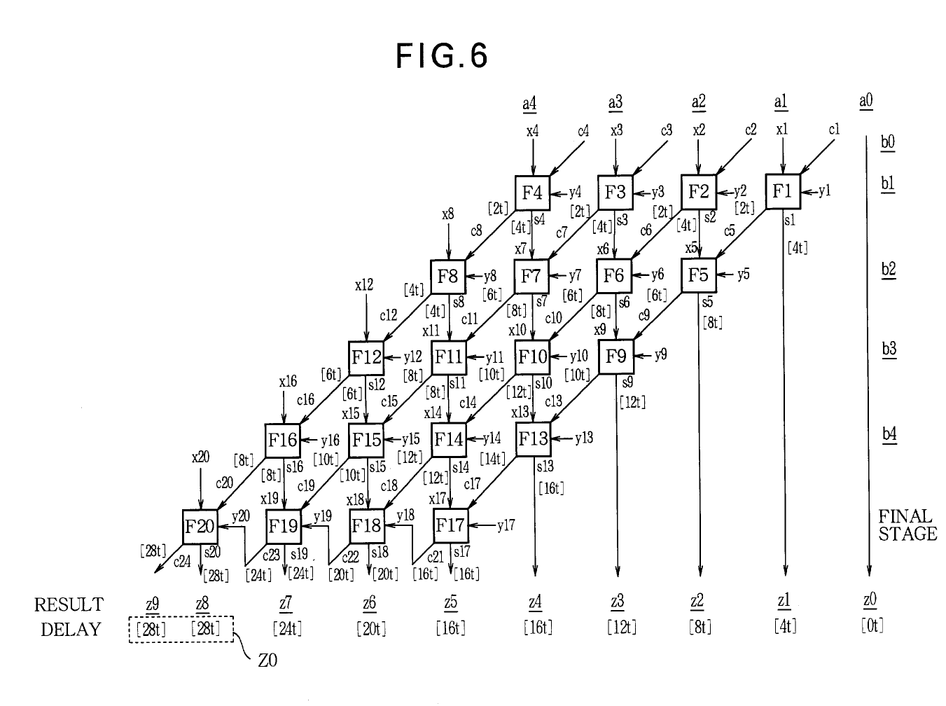

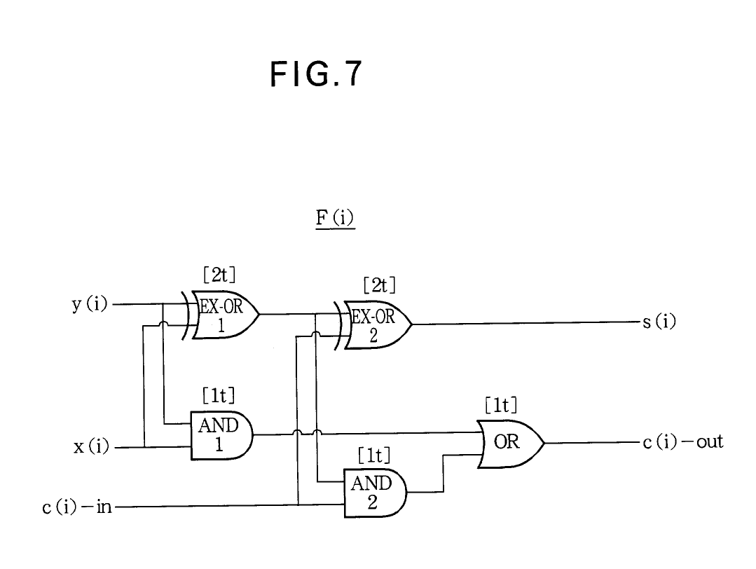

First, the operation of an adder will be described with reference to the truth table in FIG. 1. This truth table applies in general to the adders used in integrated circuits, including, for example, any one of the adders F(i) in the conventional array shown in FIG. 6. As was shown in FIG. 7, adder F(i) has input terminals for a pair of addends x(i), y(i) and a carry input signal c(i)-in generated by an operation in the preceding bit position, and has output terminals for a carry output signal c(i)-out, which is used in the addition operation performed in the next higher bit position, and the sum s(i). The logic values at these input and output terminals are indicated in separate columns in FIG. 1.

The first row (L1) in FIG. 1 indicates that when the input values are x(i)=0, y(i)=0, and c(i)-in=0, the output values are s(i)=0 and c(i)-out=0. The last or eighth row (L8) in FIG. 1 indicates that when the input values are x(i)=1, y(i)=1, and c(i)-in=1, the output values are s(i)=1 and c(i)-out=1. That is, when the three input values are all 0, the two output values are both 0, and when the three input values are all 1, the two output values are both 1.

The remaining rows (L2 to L7) in FIG. 1 cover the other two output combinations: s(i)=1 and c(i)-out=0; and s(i)=0 and c(i)-out=1. As these rows show, when the three input values are not identical, the two output values are different.

The second row (L2), third row (L3), and fifth row (L5) in FIG. 1 indicate three different input combinations that yield a single output combination: s(i)=1 and c(i)-out=0 (condition 1). The fourth row (L4), sixth row (L6), and seventh row (L7) indicate three other input combinations that yield another single output combination: s(i)=0 and c(i)-out=1 (condition 2).

In any row, it is possible to interchange any two of the inputs without changing the combination of output values. This implies that even if the corresponding input terminals are interchanged in one or more of the adders in the conventional multiplier circuit 6, the sum and carry output signal will not change.

For example, L2 and L5, which show the same output combination in FIG. 1, both have addend y(i)=0, but L2 has addend x(i)=0 and carry input signal c(i)-in=1, whereas L5 has addend x(i)=1 and carry input signal c(i)-in=0. The sum and carry output signals of this adder will not change if the input terminals for addend x(i) and carry input signal c(i)-in are interchanged.

Similarly, L1 and L6 in FIG. 1 both have addend y(i)=0, but the two other input values (addend x(i) and carry input signal c(i)-in) are both 0 in L1 and both 1 in L6. Because these two input values are the same, interchanging the input terminals for addend x(i) and carry input signal c(i)-in will, of course, not affect the sum and carry output signals.

The examples given above indicate that the input terminals for addend x(i) and carry input signal c(i)-in are interchangeable when addend y(i)=0. The examples given below will indicate that the input terminals for addend x(i) and carry input signal c(i)-in are also interchangeable when addend y(i)=1.

L4 and L7, which show the same output combination in FIG. 1, both have addend y(i)=1, but L4 has addend x(i)=0 and carry input signal c(i)-in=1, whereas L7 has addend x(i)=1 and carry input signal c(i)-in=0. The sum and carry output signals accordingly will not change if the input terminals for addend x(i) and carry input signal c(i)-in are interchanged.

L3 and L8 in FIG. 1 also have addend y(i)=1, but the two other input values (addend x(i) and carry input signal c(i)-in) are both 0 in L3 and both 1 in L8. Because these two input values are the same, interchanging the input terminals for addend x(i) and carry input signal c(i)-in will, of course, not affect the sum and carry output signal.

Therefore, if the input terminals for addend x(i) and carry input signal c(i)-in of an adder F(i) in the conventional multiplier circuit shown in FIG. 6 are interchanged, then in the truth table shown in FIG. 1, L2 and L5 are mutually interchanged, and L4 and L7 are mutually interchanged. However, the sum and carry output signals indicated in the truth table do not change. In other words, the result of multiplication by the multiplier circuit is unaffected even if the input terminals for addend x(i) and carry input signal c(i)-in of an adder F(i) are interchanged (condition 3).

It has been explained above that the input terminals for addend x(i) and carry input signal c(i)-in are. interchangeable both when addend y(i)=0 and when addend y(i)=1. It will be shown below that the input terminals for addend y(i) and carry input signal c(i)-in are interchangeable both when addend x(i)=0 and when addend x(i)=1.

L2 and L3, which show the same output combination in FIG. 1, both have addend x(i)=0, but L2 has addend y(i)=0 and carry input signal c(i)-in=1, whereas L3 has addend y(i)=1 and carry input signal c(i)-in=0. The sum and carry output signals therefore will not change if the input terminals for addend y(i) and carry input signal c(i)-in are interchanged.

L1 and L4 in FIG. 1 also have addend x(i)=0, but the two other input values (addend y(i) and carry input signal c(i)-in) are both 0 in L1 and both 1 in L4. Because these two input values are the same, interchanging the input terminals for addend x(i) and carry input signal c(i)-in will, of course, not affect the sum and carry output signal.

The examples given above indicate that the input terminals for addend y(i) and carry input signal c(i)-in are interchangeable when addend x(i)=0. The examples given below will indicate that the input terminals for addend y(i) and carry input signal c(i)-in are also interchangeable when addend x(i)=1.

L6 and L7, which show the same output combination in FIG. 1, both have addend x(i)=1, but L6 has addend y(i)=0 and carry input signal c(i)-in=1, whereas L7 has addend y(i)=1 and carry input signal c(i)-in=0. The sum and carry output signals will therefore not change if the input terminals for addend y(i) and carry input signal c(i)-in are interchanged.

L5 and L8 in FIG. 1 also have addend x(i)=1, but the other input values (addend y(i) and carry input signal c(i)-in) are both 0 in L5 and both 1 in L8. Because these two input values are the same, interchanging the input terminals for addend x(i) and carry input signal c(i)-in will, of course, not affect the sum and carry output signal.

Therefore, if the input terminals for addend y(i) and carry input signal c(i)-in of an adder F(i) in the conventional multiplier circuit shown in FIG. 6 are interchanged, L2 and L3 are mutually interchanged, and L6 and L7 are mutually interchanged in the truth table shown in FIG. 1. However, the sum and carry output signals indicated in the truth table do not change. In other words, the results of multiplication by the multiplier circuit are not affected even if the input terminals for addend y(i) and carry input signal c(i)-in of an adder F(i) are interchanged (condition 4).

From condition 3, the result of multiplication by a multiplier circuit is not affected even if the input terminals for addend x(i) and carry input signal c(i)-in of an adder F(i) are interchanged, and from condition 4, the result of multiplication by the multiplier circuit is not affected even if the input terminals for addend y(i) and carry input signal c(i)-in of an adder F(i) are interchanged. It follows that the sum generated by any adder F(i) in the conventional multiplier circuit shown in FIG. 6 is not affected even if the input terminals for addend x(i) and carry input signal c(i)-in or the input terminals for addend y(i) and carry input signal c(i)-in are interchanged (condition 5).

The delay in each adder F(i) differs depending on the path taken from input to output, as shown in FIG. 7. The paths from the input of addends x(i) and y(i) leading through two comparatively complex logic operations to the output of sum s(i) both have a 4t delay, while the path from the input of carry input signal c(i)-in leading through only one of these logic operations to the output of sum s(i) has a 2t delay. The paths from the input of addends x(i) and y(i) leading through two comparatively simple operations to the output of carry signal c(i)-out have a 2t delay. The path from the input of carry input signal c(i)-in leading through similar simple logic operations to the output of carry signal c(i)-out also has a 2t delay. As will be described below, the present invention exploits the fact that the 2t delay of the path from the input of carry input signal c(i)-in to the output of the sum s(i) is only half of the 4t delay of the paths from the input of addends x(i) and y(i) to the output of sum s(i).

The conventional multiplier circuit shown in FIG. 6 will next be studied further, together with the conditions described above and the difference in delays indicated in FIG. 7. The final delay Z0 of adder F20 generating sum s20 and carry output signal c24 is 28t, as indicated in FIG. 6. In a multiplication operation, operations are carried out in ascending order of bit position, and a carry output signal from a given bit position is output to the next higher bit position. Therefore, the delays of individual adders in the multiplier circuit will be compared and studied in ascending order of stage and bit position, or in ascending order of bit position in the multiplier and multiplicand.

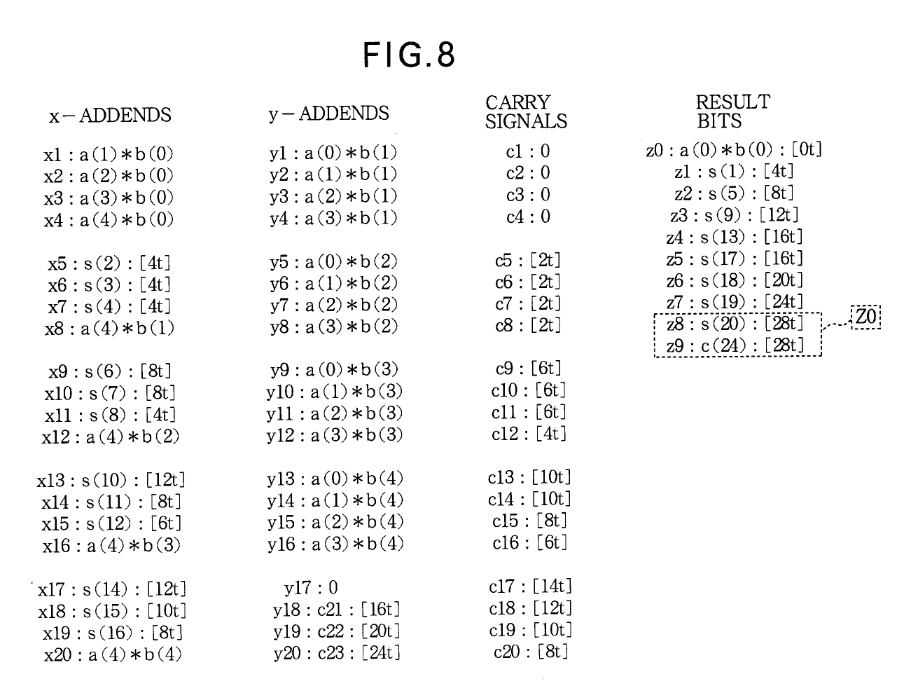

In the first stage, adders F1 to F4 receive carry input signal c(i)-in=0, and output sums s1 to s4 with a 4t delay and carry output signals c5 to c8 with a 2t delay, as shown in FIG. 8.

Adders F5 to F7 in the next stage receive addends x5 to x7 with a 4t delay and carry input signals c5 to c7 with a 2t delay, as generated by the adders in the preceding stage. For adders F5 to F7, the delay of the carry input signal c(i)-in is smaller than the delay of the input addend x(i). Adders F5 to F7 output sums s5 to s7 with an 8t delay and carry signals c9 to c11 with a 6t delay, as indicated in FIG. 6. Adder F8 in the same stage receives addend x8 without delay and carry signal c8 with a 2t delay. Because the delay of the addend is smaller than the delay of the carry input signal, the corresponding input terminals will not be interchanged.

If the input terminals for addends x5 to x7 and the input terminals for carry input signals c5 to c7 are interchanged in adders F5 to F7 because of the differences in delay indicated in FIG. 7, under the conditions described above, adders F5 to F7 will output sums s5 to s7 with a 6t delay and carry output signals c9 to c11 with a 6t delay. The delay of sums s5 to s7 is reduced from 8t to 6t by interchanging the input terminals.

### First Embodiment

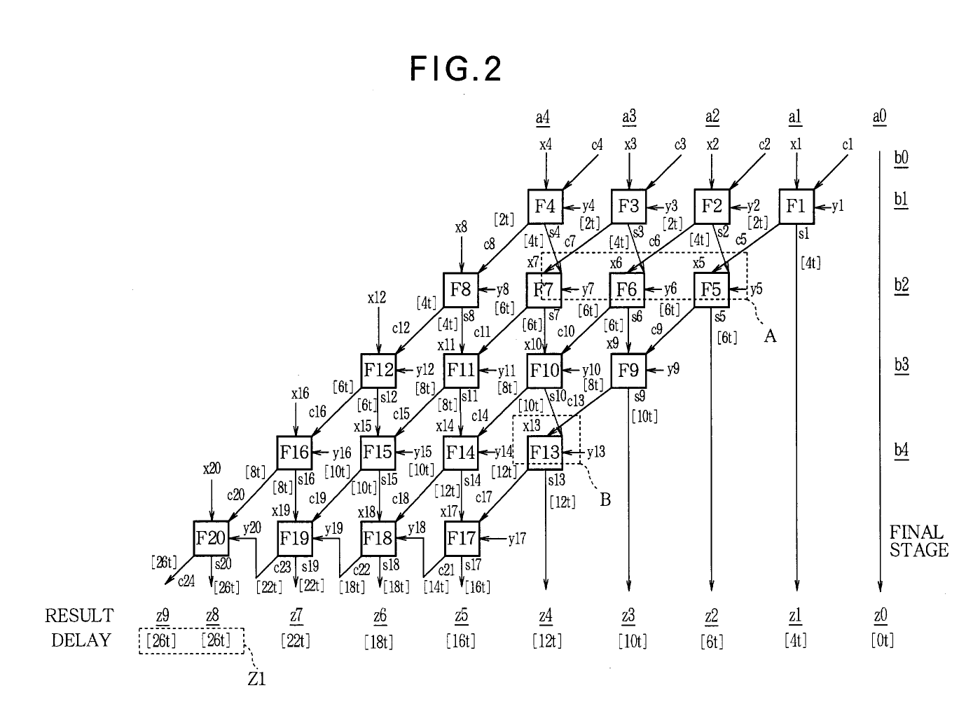

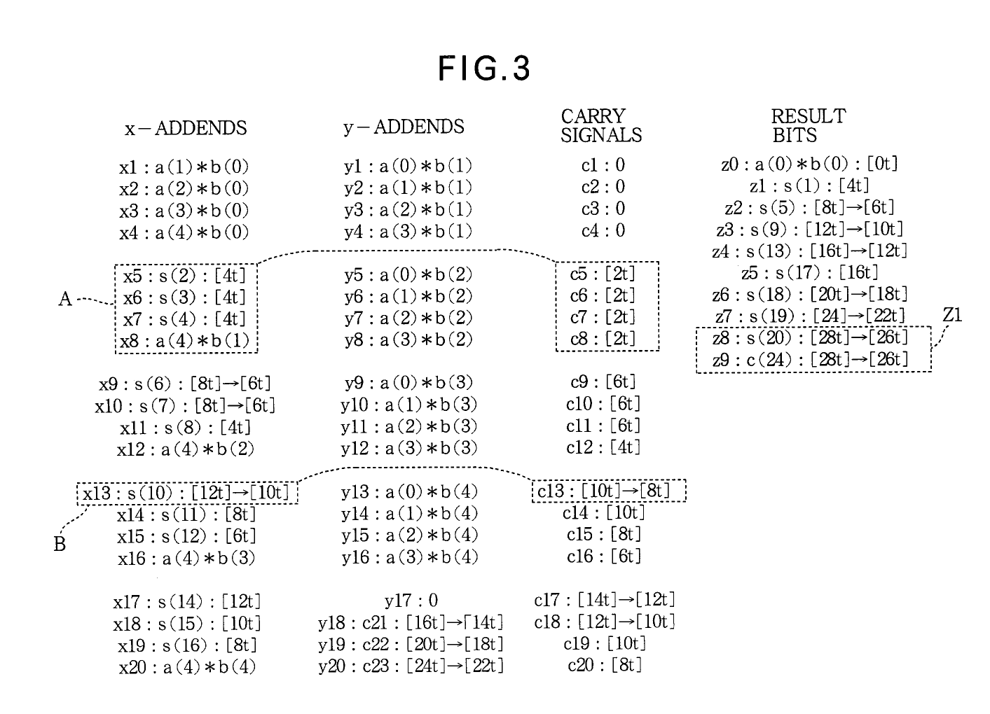

FIG. 2 is a block diagram of a multiplier circuit comprising an array of one-bit adders, illustrating a first embodiment of the invention. FIG. 3 lists the inputs and outputs of the adders in the multiplier circuit shown in FIG. 2.

Elements in FIGS. 2 and 3 having the same function as elements in the conventional multiplier circuit shown in FIGS. 6 and 8 are indicated by identical reference characters; redundant descriptions will be omitted. The delays of the following inputs are all zero: addends x1 to x4, x8, x12, x16, x20, and y1 to y17, and carry input signals c1 to c4. Some delays have been reduced by interchanging the input terminals as described above. The reduced delays are italicized in FIG. 2.

In the first embodiment, the input terminals of addend x(i) and carry input signal c(i) are interchanged in some cases to reduce the delay.

The first embodiment illustrated in FIG. 2 differs from the prior art illustrated in FIG. 6 in that the input terminals for addends x5 to x7 and the input terminals for carry input signals c5 to c7 are interchanged in adders F5 to F7, and the input terminals for addend x13 and carry input signal c13 of adder F13 are interchanged. In other respects, the first embodiment is configured in the same manner as the prior art illustrated in FIG. 6.

Box A in FIG. 2 indicates that the input terminals for addends x5 to x7 and the input terminals for carry input signals c5 to c7 are interchanged in adders F5 to F7.

In the third stage, adders F9 and F10 receive addends x9 and x10 with a 6t delay, which has been reduced by interchanging the input terminals for addends x5 to x7 and the input terminals for carry input signals c5 to c7 in adders F5 to F7, as indicated in box A of FIG. 2. Because this delay is the same as the 6t delay of carry input signals c9 and c10, the corresponding input terminals do not need to be interchanged. Adder F11 receives addend x11 with a 4t delay and carry input signal c11 with a 6t delay. Because the delay of addend x11 is not larger than the 6t delay of the carry input signal c11, the corresponding input terminals do not need to be interchanged. Adder F12 receives addend x12 without delay and carry input signal c12 with a 4t delay. Because the delay of the carry input signal is longer, the input terminals do not need to be interchanged.

In the fourth stage, adder F13 receives addend x13 with a 12t delay and carry input signal c13 with a 10t delay, from the adders in the preceding stage. Because the delay of addend x13 is larger than the delay of carry input signal c13, the corresponding input terminals have been interchanged, as indicated in box B in FIG. 2.

Adder F14 in the fourth stage receives addend x14 with an 8t delay and carry input signal c14 with an 8t delay. Because the delays are the same, the corresponding input terminals do not need to be interchanged. Adder F15 receives addend x15 with a 6t delay and carry input signal c15 with an 8t delay. Because the delay of addend x15 is smaller than the delay of carry input signal c15, the corresponding input terminals do not need to be interchanged. Adder F16 receives addend x16 without delay and carry input signal c16 with a 6t delay. Because the delay of the carry output signal is larger, the input terminals need not be interchanged.

In the last stage, adder F17 receives addend x17 with a 12t delay and carry input signal c17 with a 12t delay, and adder F18 receives addend x18 with a 10t delay and carry input signal c18 with a 10t delay. Because the delays are the same, the corresponding input terminals do not need to be interchanged. Adder F19 receives addend x19 with an 8t delay and carry input signal c19 with a 10t delay. Because the delay of addend x19 is smaller than the delay of the carry input signal, the corresponding input terminals do not need to be interchanged. Adder F20 receives addend x20 without delay and carry input signal c20 with an 8t delay. Because the delay of the carry input signal is larger, the input terminals do not need to be interchanged.

As a result of interchanging the input terminals for addend x(i) and carry input signal c(i)-in of adders F5 to F7 and F13, the delay of the carry output signals c21 to c24 of adders F17 to F20 can be reduced by 2t, and the delay of the sum signals s18 to s20 output from adders F18 to F20 can be reduced by 2t. The final delay Z1 of the multiplier shown in FIG. 2 becomes 26t, which is 2t smaller than the 28t delay of the conventional multiplier indicated in Z0 of FIG. 6.

In the integrated multiplier circuit of the first embodiment, a plurality of one-bit adders are disposed in an array with a plurality of stages and a plurality of bit positions, so that the bits of the multiplier and multiplicand are input to different adders in positional sequence, and each adder outputs a sum to the adder in the same bit position in the next stage and a carry signal to the adder in the next-higher bit position of the next stage. If the delay of the sum generated by an adder of the preceding stage is larger than the delay of the carry signal generated by the adder in the next-lower bit position of the preceding stage, the input terminals for the sum and carry signal are interchanged. In order to determine whether the input terminals for the sum and carry signal should be interchanged, the delays of the sum and carry signal input to each adder are compared in ascending order of bit position of the multiplier and multiplicand. The delay of this integrated multiplier circuit is thereby reduced.

### Second Embodiment

In the first embodiment described above, the delay of the integrated multiplier circuit was reduced by interchanging the input terminals for addend x(i) and carry input signal c(i)-in of some one-bit adders. The input terminals for addend y(i) and carry input signal c(i) could also be interchanged, but in almost all cases, specifically in adders F1 to F17, this is not necessary, because the delays of addends y1 to y17 are all zero, and thus do not exceed the delay of the carry input signal c(i)-in.

In the second embodiment, the delay is further reduced by interchanging the input terminals for addend y(i) and carry input signal c(i)-in of adders F18 to F20.

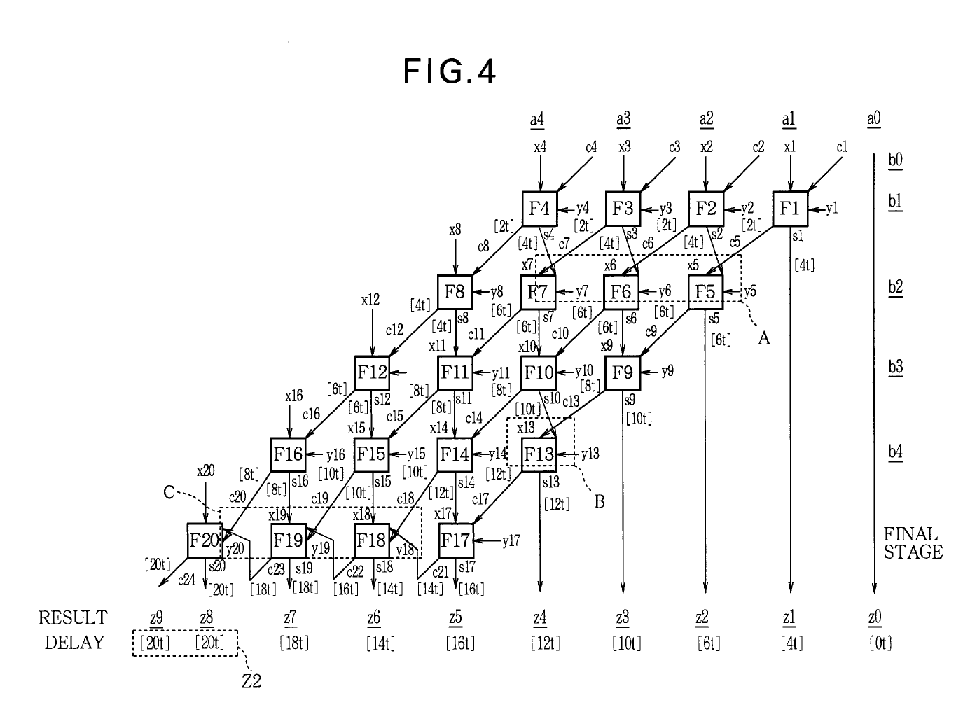

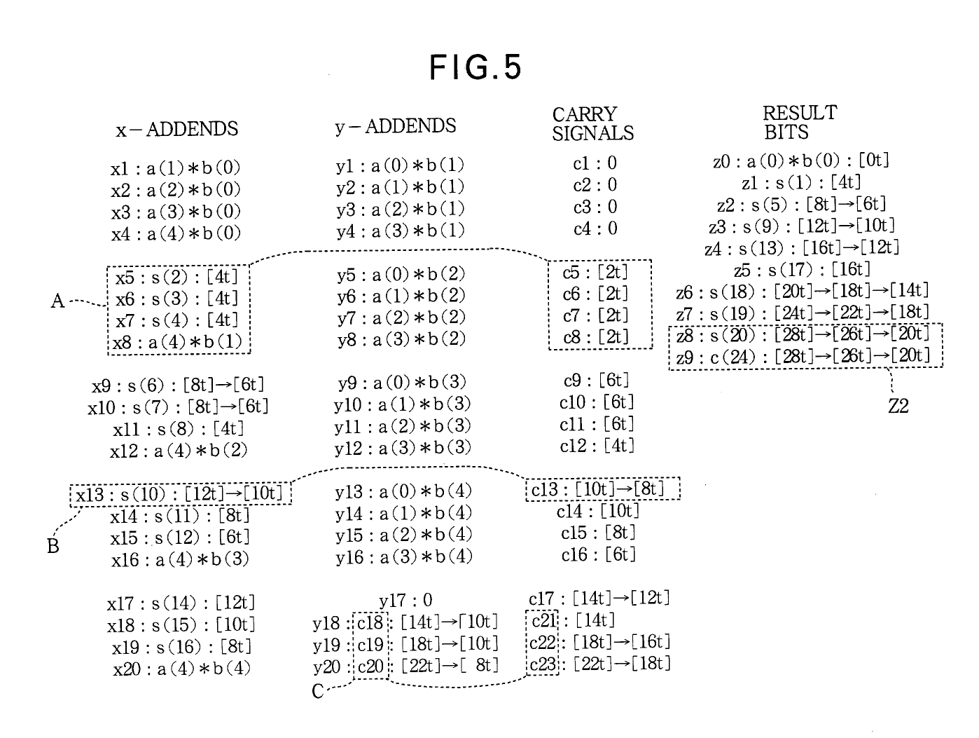

FIG. 4 is a block diagram of a multiplier circuit comprising an array of one-bit adders, illustrating the second embodiment of the invention. FIG. 5 lists the inputs and outputs of the adders in the multiplier circuit shown in FIG. 4.

The second embodiment illustrated in FIGS. 4 and 5 differs from the first embodiment illustrated in FIGS. 2 and 3 in that the input terminals for addends y18 to y20 and the input terminals for carry input signals c18 to c20 are interchanged in adders F18 to F20, as indicated in box C of FIG. 4.

Adder F18 receives addend y18 with a 14t delay and carry input signal c18 with a 10t delay. Because the 14t delay of addend y18 is larger than the 10t delay of carry input signal c18, the corresponding input terminals are interchanged to reduce the delay in adder F18. The delays of carry signal c22 and sum s18 output from adder F18 with interchanged input terminals are reduced by 2t and 4t respectively, in comparison with the first embodiment.

Adder F19 receives addend y19 with a 16t delay and carry input signal c19 with a 10t delay. Because the 16t delay of addend y19 is larger than the 10t delay of carry input signal c19, the corresponding input terminals are interchanged to reduce the delay in adder F19. The delays of carry output signal c23 and sum s19 output from adder F19 with interchanged input terminals are both reduced by 4t, in comparison with the first embodiment.

Adder F20 receives addend y20 with an 18t delay and carry input signal c20 with an 8t delay. Because the 18t delay of addend y20 is larger than the 8t delay of carry input signal c20, the corresponding input terminals are interchanged to reduce the delay in adder F20. The delays of carry output signal c24 and sum s19 output from adder F20 with interchanged input terminals are both reduced by 6t, in comparison with the first embodiment.

In the integrated multiplier circuit of the second embodiment, a plurality of one-bit adders are disposed in an array with a plurality of stages and a plurality of bit positions, so that the bits of the multiplier and multiplicand are input to different adders in positional sequence, and each adder outputs a sum to the adder (if any) in the same bit position in the next stage and a carry signal to the adder in the next-higher bit position of the next stage. Each adder thus receives sum and carry signals from adders in the preceding stage. Normally the sum signal is received at an addend input terminal and the carry signal at a carry input terminal, but if the carry signal is received with less delay than the sum signals, the two input terminals are interchanged, thereby reducing the total critical-path delay, as in the first embodiment.

The carry signal from an adder in the final stage is routed to the adder in the next-higher bit position in the same final stage. Thus a typical adder in the final stage receives the carry signal generated by the adder in the next-lower bit position of the preceding stage and the carry signal generated by the adder in the next-lower bit position in the final stage. Normally, the carry signal from the preceding stage is brought to the carry input terminal and the carry signal from the final stage is brought to an addend input terminal of the adder, but if the delay of the carry signal from the preceding stage is less than the delay of the carry signal from the final stage, these two input terminals are interchanged. In order to determine whether these two inputs should be interchanged, the delays of the carry signals input to the adders are compared in ascending order of bit position of the multiplier and multiplicand. The critical-path delay of the integrated multiplier circuit is thereby further reduced.

The adders in the first and second embodiments may have the internal logic structure indicated as an example in FIG. 7, or a different internal logic structure. FIGS. 2 and 4 indicate exemplary circuits for a five-bit multiplier, but the invented multiplier can have any number of bits. In the embodiments described above with reference to FIGS. 2 and 4, the input terminals of adders F5 to F7, F13, and F18 to F20 are interchanged, but the adders may be configured in a different manner, depending on the bit configuration, and the input terminals of adders in different bit positions may be interchanged on the basis of comparisons between the delays of either addend and the carry input signal.

The scope of the invention should accordingly be determined from the appended claims.

What is claimed is:

1. An integrated multiplier circuit having a plurality of one-bit adders generating respective sum signals and carry signals, the one-bit adders being disposed in an array with a plurality of stages and a plurality of bit positions, the sum signals being supplied from one stage to the next, the carry signals being supplied from one bit position to the next, the sum signals and carry signals being received with respective delays, wherein:
each adder in the array has a pair of addend input terminals and a carry input terminal;
at least one adder in the array receives one of the sum signals at one of its addend input terminals, and receives one of the carry signals at its carry input terminal; and
at least one other adder in the array receives another one of the sum signals at its carry input terminal, and receives another one of the carry signals at one of its addend input terminals.

2. The integrated multiplier circuit of claim 1, wherein said another one of the sum signals is received at the carry input terminal if said another one of the sum signals is received with greater delay than said another one of the carry signals.

3. The integrated multiplier circuit of claim 2, wherein the receiving delay of the sum signals and the carry signals is determined by comparing the sum signals and carry signals in ascending order of stage and ascending order of bit position.

4. The integrated multiplier of claim 1, wherein at least one adder in a final stage of the array receives a first one of the carry signals from a preceding stage of the array and receives a second one of the carry signals from another adder in the final stage of the array, the second one of the carry signals being received at the carry input terminal.

5. The integrated multiplier circuit of claim 1, wherein said second one of the carry signals is received at the carry input terminal if said second one of the carry signals is received with greater delay than said first one of the carry signals.

6. The integrated multiplier circuit of claim 5, wherein the receiving delay of the carry signals received in the final stage of the array is determined by comparing the carry signals in ascending order of bit position.

7. A method of interconnecting an array of one-bit adders in an integrated multiplier circuit, the array being organized into a plurality of stages from a first stage and a final stage, with a plurality of bit positions in each stage, each one-bit adder in the array having three input terminals for receiving respective signals and two output terminals for output of respective signals, each interconnection extending from one of the output terminals of one of the one-bit adders in the array to a predetermined one-bit adder in a later stage of the array or a higher bit position in the same stage of the array, the three input terminals of each one-bit adder in the array including a first terminal, a second terminal, and a third terminal, the signal received at the third terminal being processed with less internal delay than the signals received at the first and second terminals, the method comprising:
considering the one-bit adders one by one, proceeding from the first stage to the final stage in the array and from the lowest bit position to the highest bit position in each stage;
comparing delays of the three signals received by the adder under consideration;
assigning the three signals received by the one-bit adder under consideration to the three input terminals of the one-bit adder under consideration, a signal received with maximum delay being assigned to the third terminal; and
calculating delays of the two signals output from the one-bit adder under consideration.

8. The method of claim 7, wherein the third terminal is a carry input terminal.

9. The method of claim 7, wherein the three signals received by each adder in the first stage of the array are considered to be received with zero delay.

10. The method of claim 7, wherein:
the two output terminals of each one-bit adder include a sum output terminal for output of a sum signal and a carry output terminal for output of a carry output signal;
the sum signal output from each one-bit adder is supplied to a one-bit adder, if present, in the same bit position in the next stage of the array;
the carry signal output from each one-bit adder in each stage of the array except the final stage is supplied to a one-bit adder in a next higher bit position in the next stage of the array; and
the carry signal output from each one-bit adder in the final stage of the array is supplied to a one-bit adder, if present, in the next-higher bit position in the final stage of the array.
